(19) United States
(12) Patent Application Publication
(10) Pub. No.: US 2026/0227729 A1
(43) Pub. Date: Aug. 6, 2026

(54) FIXING DEVICE AND IMAGE FORMING APPARATUS

(71) Applicant: Sharp Kabushiki Kaisha, Osaka (JP)

(72) Inventor: TOMOHIRO MAEDA, Osaka (JP)

(21) Appl. No.: 19/443,248

(22) Filed: Jan. 8, 2026

(30) Foreign Application Priority Data
Jan. 30, 2025 (JP) 2025-013823

(51) Int. Cl. G03G 15/20; G03G 15/00; H05B 3/22

(52) U.S. Cl. CPC G03G 15/2053; G03G 15/2064; G03G 15/80; H05B 3/22; G03G 2215/2035

(57) ABSTRACT

A fixing device includes a heater, and the heater includes a heater base material, first electrode portions that are respectively provided at both end portions of a first surface of the heater base material, second electrode portions that are respectively provided at both end portions of a second surface of the heater base material, a first heat generation body that is formed between the two first electrode portions on the first surface, and generates heat by energization, and a second heat generation body that is formed between the two second electrode portions on the second surface, and generates heat by energization. The first electrode portion and the second electrode portion are provided at positions that at least partially overlap with each other in a longitudinal direction as viewed in a thickness direction.

### CROSS-REFERENCE TO RELATED APPLICATION

The present application claims priority from Japanese Application JP2025-013823, the content of which is hereby incorporated by reference into this application.

### BACKGROUND OF THE INVENTION

### Field of the Invention

The present disclosure relates to an image forming apparatus such as a copier, a multifunctional apparatus, a printer, and a facsimile machine apparatus, and a fixing device of the image forming apparatus.

### Description of the Related Art

Hitherto, there has been provided a fixing device that thermally fixes an unfixed image formed on a sheet in an image forming apparatus. For example, in the related art, an image forming apparatus in which a heater is provided to a heating device has been known. In the related-art heater, an energizing heat-generating resistance layer that generates heat by energization is provided on one surface of a substrate. Further, in the related-art heater, electrode portions are formed at both end portions of the energizing heat-generating resistance layer.

### SUMMARY OF THE INVENTION

Incidentally, when a power supply connector is connected to the electrode portion as in the related art, it is required to provide the electrode portions respectively at both ends of the energizing heat-generating resistance layer in the longitudinal direction, and it is also required to secure a space having a certain size in the longitudinal direction. Further, when one heat generation pattern is formed as in the related-art heater, the electrode portions are only required to be provided at two locations, namely both ends of the energizing heat-generating resistance layer. However, when two or more heat generation patterns are formed, it is required to provide four electrode portions, which causes a problem that the size of the heater in the longitudinal direction is further increased.

For example, in recent years, there has been provided an image forming apparatus including a heater provided with two heat generation patterns so that the heat generation patterns are switched in accordance with a sheet width. More specifically, there has been provided an image forming apparatus including two heat generation patterns, specifically, a heat generation body that heats a center portion of a sheet passing region and a heat generation body that heats both end portions of the sheet passing region as heat generation patterns. In a case of the heater provided with the two heat generation patterns, two electrode portions are required for each heat generation pattern (heat generation body), and hence four electrode portions in total are required.

For example, as in a heater 100 illustrated in a reference diagram in FIG. 6, when a first heat generation body 102a corresponding to a center portion of a sheet passing region and a second heat generation body 102b corresponding to both end portions of the sheet passing region are provided on a front surface 101a (one surface) of a heater base material 101, four electrode portions 103, specifically, two electrode portions 103a of the first heat generation body 102a and two electrode portions 103b of the second heat generation body 102b are required to be provided and arrayed in a longitudinal direction B, and hence a larger space is required in the longitudinal direction B.

In this manner, when a plurality of heat generation patterns are to be provided, a space required in a longitudinal direction of a heater is also increased. However, there is a demand to reduce a size of a heater in a longitudinal direction while providing a plurality of heat generation patterns and utilize the space as an arrangement space for other members.

In view of this, an object of the present disclosure is to provide a fixing device that can suppress an increase in size of a heater in a longitudinal direction while providing a plurality of heat generation patterns, and an image forming apparatus.

In order to solve the above-mentioned problem, the present disclosure provides a fixing device that fixes an image on a sheet conveyed along a conveyance path, the fixing device including a pressure roller, a fixing belt that has an endless shape and rotates in conjunction with rotation of the pressure roller, a fixing pad that slides with respect to an inner circumferential surface of the fixing belt and forms a fixing nip portion while nipping the fixing belt between the fixing pad and the pressure roller, and a heater that is provided to the fixing pad. The heater includes a heater base material that has a plate-like shape, first electrode portions that are respectively provided at both end portions of the heater base material in a longitudinal direction on a first surface being one of front and back surfaces of the heater base material, second electrode portions that are respectively provided at both the end portions on a second surface of the front and back surfaces of the heater base material, the second surface being different from the first surface, a first heat generation body that is formed to extend along the longitudinal direction between the two first electrode portions on the first surface and generates heat by energization, and a second heat generation body that is formed to extend along the longitudinal direction between the two second electrode portions on the second surface and generates heat by energization. The first electrode portion and the second electrode portion are provided at positions that at least partially overlap with each other in the longitudinal direction as viewed in a thickness direction of the heater base material.

According to the present disclosure, it is possible to provide a fixing device that can suppress an increase in size of a heater in a longitudinal direction while providing a plurality of heat generation patterns, and an image forming apparatus.

### BRIEF DESCRIPTION OF THE DRAWINGS

FIG. 1 is a schematic view illustrating an inside of an image forming apparatus according to an embodiment of the present disclosure.

FIG. 2 is a cross-sectional view illustrating a fixing device of the image forming apparatus in FIG. 1.

FIG. 3 illustrates a state in which a heater of the fixing device in FIG. 2 is viewed in a thickness direction. The upper part of FIG. 3 illustrates a back surface (second surface), and the lower part of FIG. 3 illustrates a front surface (first surface).

FIG. 4 is a cross-sectional view taken along the line A1-A1 of the heater in the lower part of FIG. 3.

FIG. 5 is a view illustrating a state in which another example of the heater in FIG. 3 is viewed in the thickness direction. The upper part of FIG. 5 illustrates a back surface (second surface), and the lower part of FIG. 5 illustrates a front surface (first surface).

FIG. 6 is a reference view illustrating a heater in which two heat generation patterns are provided on one surface of a heater base material.

### DETAILED DESCRIPTION OF THE INVENTION

An image forming apparatus 1 according to an embodiment of the present disclosure is described below with reference to the drawings. In the following description, the same components are denoted by the same reference numerals. Their names and functions are also the same. Accordingly, detailed descriptions thereof are not repeated.

### Image Forming Apparatus

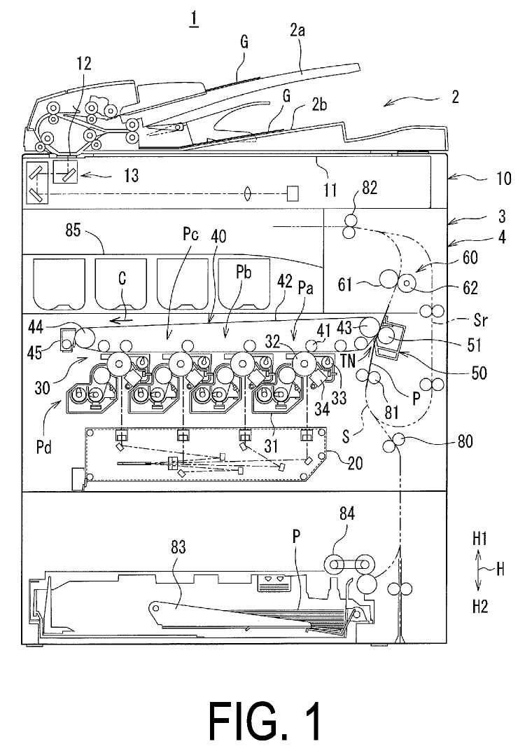

FIG. 1 is a cross-sectional view illustrating a schematic configuration of the image forming apparatus 1 including a fixing device 60 according to the present embodiment.

In the following description, the up-down direction in the state where the image forming apparatus 1 is installed is referred to as an "up-down direction H". In addition, the upper side in the up-down direction H is referred to as an "upper side H1", and the lower side is referred to as a "lower side H2".

As illustrated in FIG. 1, the image forming apparatus 1 is a multifunctional apparatus having a copy function, a scanner function, a facsimile machine function, and a printer function. As illustrated in FIG. 1, the image forming apparatus 1 includes a document feeding device 2 and an apparatus main body 3.

The image forming apparatus 1 transmits an image of a document G that is read by an image reader 10 to the outside. In addition, the image forming apparatus 1 forms the image of the document G that is read by the image reader 10 or an externally received image on a sheet P such as a recording sheet in color or monochrome. The image forming apparatus 1 may be a monochrome image forming apparatus. In addition, the image forming apparatus 1 may be a color image forming apparatus of another type.

The document feeding device 2 is supported in an openable and closable manner with respect to the apparatus main body 3 (the image reader 10). The document feeding device 2 includes a document placement tray 2a on which the document G is placed and a document discharge tray 2b on which the documents G having been discharged are stacked. The document feeding device 2 sequentially conveys one or a plurality of the documents G placed on the document placement tray 2a one by one onto a document reader 12 of the image reader 10, and discharges the documents G onto the document discharge tray 2b.

The apparatus main body 3 includes the image reader 10, an optical scanning device 20, an image former 30, an intermediate transfer belt device 40, a secondary transfer device 50, the fixing device 60, a sheet conveyance path S, a sheet feeding cassette 83, and a sheet discharge tray 85. As illustrated in FIG. 1, the apparatus main body 3 has a configuration in which configurations such as the image reader 10, the image former 30, and the sheet feeding cassette 83 are accommodated in a housing 4.

The image reader 10 reads document G conveyed by the document feeding device 2. Further, the image reader 10 is provided with a document placement table 11 on which the document G is placed. The image reader 10 reads the document G placed on the document placement table 11. In the image forming apparatus 1, when the document feeding device 2 is opened, the document placement table 11 on the upper side H1 of the image reader 10 is opened, and the document G can be manually placed thereon. The image reader 10 scans the document G conveyed by the document feeding device 2 with a scanning optical system 13 positioned at a reading position on the lower side H2 of the document reader 12 or uses the scanning optical system 13 to scan the document G placed on the document placement table 11 to generate image data.

The image forming apparatus 1 deals with image data corresponding to a color image made of individual colors of black (K), cyan (C), magenta (M), and yellow (Y), or a monochrome image made of a single color (for example, black). The image former 30 is provided with four sets of a development device 31, four sets of a photoreceptor drum 32, four sets of a drum cleaning device 33, and four sets of a charger 34 that form four types of toner images, with the sets respectively serving as image stations Pa, Pb, Pc, Pd corresponding to the colors black, cyan, magenta, and yellow, respectively.

The charger 34 uniformly charges the front surface of the photoreceptor drum 32 to a predetermined potential. The optical scanning device 20 exposes the front surface of the photoreceptor drum 32 to form an electrostatic latent image. The development device 31 develops the electrostatic latent image on the front surface of the photoreceptor drum 32 to form a toner image on the front surface of the photoreceptor drum 32. The drum cleaning device 33 removes and collects residual toner on the front surface of the photoreceptor drum 32. With the series of operations described above, the toner images of the respective colors are formed on the front surfaces of the respective photoreceptor drums 32.

The intermediate transfer belt device 40 includes an intermediate transfer roller 41, an intermediate transfer belt 42 having an endless shape, an intermediate transfer driving roller 43, an intermediate transfer driven roller 44, and a cleaning device 45. Four sets of the intermediate transfer roller 41 are provided on the inner side of the intermediate transfer belt 42 to form the four types of toner images corresponding to the respective colors. The intermediate transfer rollers 41 transfer the toner images of the respective colors formed on the front surfaces of the photoreceptor drums 32 to the intermediate transfer belt 42 that rotates in a rotation direction C.

The intermediate transfer belt 42 is stretched over the intermediate transfer driving roller 43 and the intermediate transfer driven roller 44. In the image forming apparatus 1, the toner images of the respective colors formed on the front surfaces of the respective photoreceptor drums 32 are sequentially transferred and superimposed on the front surface of the intermediate transfer belt 42 to form color toner images on the front surface of the intermediate transfer belt 42.

In the secondary transfer device 50, a transfer nip portion TN is formed between the secondary transfer roller 51 and the intermediate transfer belt 42, and the sheet P conveyed along the sheet conveyance path S is conveyed while being nipped at the transfer nip portion TN.

When the sheet P passes through the transfer nip portion TN, the toner image on the front surface of the intermediate transfer belt 42 is conveyed by the secondary transfer device 50 onto the sheet P. Then, the sheet P is conveyed to the fixing device 60. The cleaning device 45 removes and collects waste toner that remains on the front surface of the intermediate transfer belt 42 without being transferred to the sheet P.

The fixing device 60 includes a fixing belt 61 and a pressure roller 62 that nip the sheet P and rotate. In the fixing device 60, the sheet P with the transferred toner image is nipped between the fixing belt 61 and the pressure roller 62, and is subjected to heating and pressure to fix the toner image (image) onto the sheet P. Details of the fixing device 60 are described below.

Conveying rollers 80, registration rollers 81, and discharge rollers 82 are arranged along the sheet conveyance path S. The conveying rollers 80 facilitate the conveyance of the sheet P. The registration rollers 81 temporarily stop the sheet P, and align a leading edge of the sheet P. The registration rollers 81 convey the temporarily stopped sheet P in synchronization with the timing of the toner image on the intermediate transfer belt 42.

The sheet feeding cassette 83 is a cassette for storing the sheets P to be used for image formation, and is provided on the lower side H2 of the optical scanning device 20. The sheet P is pulled out from the sheet feeding cassette 83 by a pickup roller 84 and conveyed to the sheet conveyance path S. The sheet P having been conveyed to the sheet conveyance path S is conveyed to the discharge rollers 82 via the secondary transfer device 50 and the fixing device 60, and is discharged to the sheet discharge tray 85.

Note that, in FIG. 1, one sheet feeding cassette 83 is provided, but no such limitation is intended. A configuration with a plurality of the sheet feeding cassettes 83 may be used, with different sheet feeding cassettes 83 being loaded with different types of the sheets P. Further, in a case where the image forming apparatus 1 forms an image not only on the surface but also on the rear surface of the sheet P, the sheet P is conveyed in the reverse direction from the discharge rollers 82 to a sheet reverse path Sr. The image forming apparatus 1 reverses the front and rear of the sheet P having been conveyed in the reverse direction, and guides the sheet P again to the registration rollers 81. Further, the image forming apparatus 1 forms an image on the rear surface of the sheet P guided to the registration rollers 81 similarly to the case of forming an image on the surface of the sheet P, and conveys the sheet P to the sheet discharge tray 85.

### Embodiments

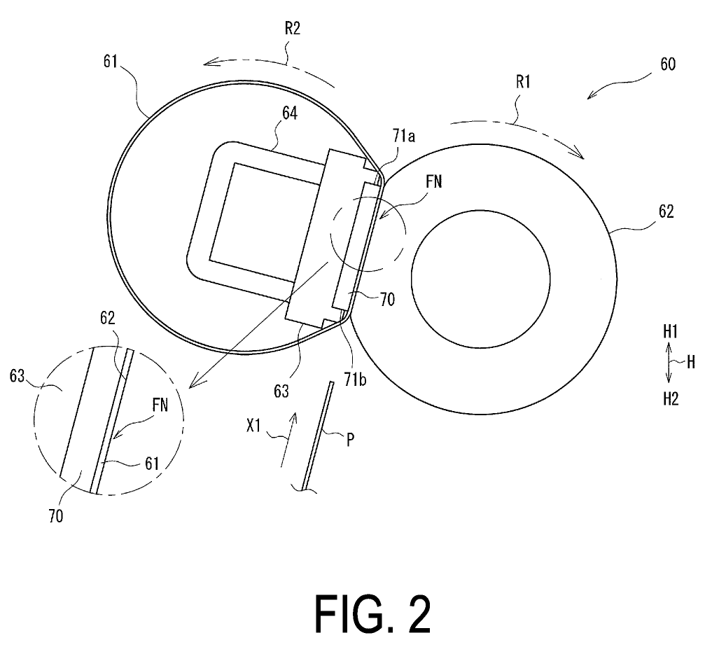

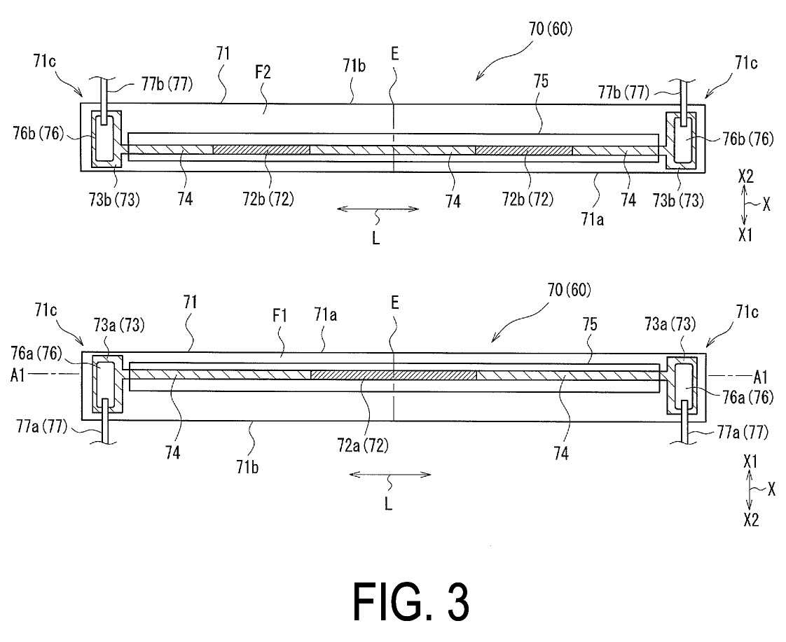

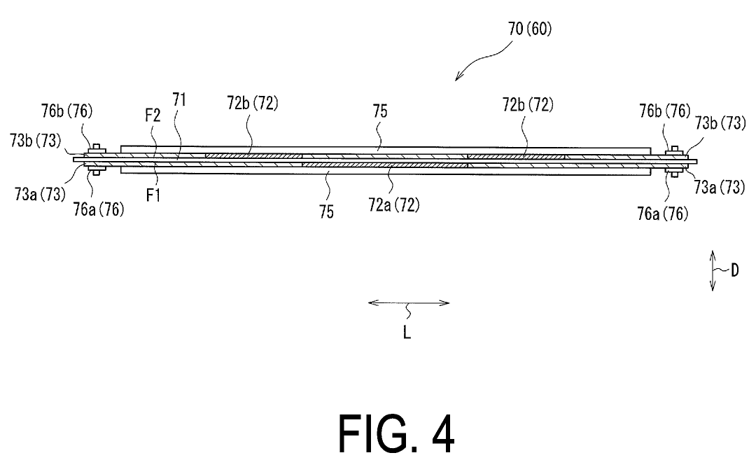

Next, an embodiment of the present disclosure is described. FIG. 2 is a cross-sectional view illustrating the fixing device 60 of the image forming apparatus 1 according to the present disclosure. FIG. 3 illustrates a state in which a heater 70 of the fixing device 60 is viewed in a thickness direction D. The upper part of FIG. 3 illustrates a back surface (second surface F2), and the lower part of FIG. 3 illustrates a front surface (first surface F1). FIG. 4 is a cross-sectional view taken along the line A1-A1 of the heater 70 in the lower part of FIG. 3.

### Fixing Device

As illustrated in FIG. 2, in addition to the fixing belt 61 and the pressure roller 62, the fixing device 60 includes a fixing pad 63, a support member 64, and the heater 70. The support member 64, the fixing pad 63, and the heater 70 are provided on the inner side of the fixing belt 61. Further, the fixing pad 63 is arranged on the inner circumferential side of the fixing belt 61 while being supported by the support member 64. The fixing device 60 fixes an image on the sheet P conveyed along a conveyance direction X1.

The fixing belt 61 is an endless (ring-like) flexible belt. The fixing belt 61 is rotatable about a rotation axis along a direction orthogonal to the conveyance direction X1. As illustrated in FIG. 2, the fixing belt 61 is provided so as to contact with the pressure roller 62, and rotates in conjunction with rotation of the pressure roller 62.

The pressure roller 62 is arranged at a position facing the fixing pad 63 with the fixing belt 61 therebetween. The pressure roller 62 rotates about a rotation axis parallel to the rotation axis of the fixing belt 61, and extends parallel to the fixing belt 61. The pressure roller 62 presses the fixing belt 61 toward the fixing pad 63, and forms a fixing nip portion FN between the pressure roller 62 and the fixing belt 61.

The pressure roller 62 can be constituted by a roller member in which, for example, a surface of a cylindrical core formed of a metal such as aluminum is covered with an elastic material such as rubber.

The driving force from a driving source (not illustrated) such as a motor is transmitted to the pressure roller 62 through a drive transmission mechanism (not illustrated) such as a gear. The pressure roller 62 is driven into rotation with a driving force from the driving source. The fixing belt 61 is driven to rotate in a second rotation direction R2 opposite to a first rotational direction R1 of the pressure roller 62, in association with rotational driving of the pressure roller 62. In other words, the pressure roller 62 abuts against the surface of the fixing belt 61, and thus forms the fixing nip portion FN. The pressure roller 62 transmits a driving force to the fixing belt 61 via the fixing nip portion FN, and the fixing belt 61 is driven to rotate.

The fixing pad 63 is formed of a resin and is formed to have a long plate-like shape extending in a rotation axis direction of the fixing belt 61, for example. A resin material having heat resistance is preferably used as the fixing pad 63, and a heat-resistant resin material having heat resistance such as liquid crystal polymer (LCP) or PEEK (polyether ether ketone) can be used, for example.

Both end portions of the support member 64 in the rotation axis direction are fixed to a fixing device main body, which is omitted in the illustration.

The heater 70 is a member for heating the fixing belt 61. The heater 70 extends in the rotation axis direction of the fixing belt 61. The heater 70 is attached to the fixing pad 63, and includes one surface facing the fixing belt 61 (see an enlarged view of the main part in the lower left part of FIG. 2). As illustrated in FIG. 3, the heater 70 includes a heater base material 71, a heat generation body 72, an electrode portion 73, a conductive portion 74, an insulating layer 75, and a power supply terminal 76. A lead wire 77 serving as a power supply path from the power source extends from each of the power supply terminals 76.

As illustrated in FIG. 3, the heater base material 71 of the present embodiment is a rectangular plate-like member. The heater base material 71 is arranged so that the longitudinal direction thereof extends along the axis of the pressure roller 62. The heater base material 71 may use a material having high electrical insulating properties and high thermal conductivity.

The heater base material may employ, for example, materials such as ceramics, alumina, or aluminum nitride. A thickness of the heater base material can be variously selected. The heater base material may have, for example, a thickness of about 0.5 to 2.0 millimeters. For example, when alumina is used as the material of the heater base material, the thickness may be about 0.5 to 1.0 millimeters. When aluminum nitride is used as the material of the heater base material, the thickness may be about 0.5 to 0.7 millimeters, for example.

In this specification, the longitudinal direction of the heater 70 and the heater base material 71 is simply referred to as a “longitudinal direction L”. Further, in this specification, one surface of the front and back surfaces of the heater base material 71 is referred to as the “first surface F1”, and the other surface is referred to as the “second surface F2”. Note that, in the present embodiment, the heater base material 71 is arranged so that the first surface F1 faces the fixing belt 61. Further, in the present embodiment, the first surface F1 is a surface (heating surface) that contacts with the fixing belt 61 and heats the fixing belt 61.

In this specification, the thickness direction of the heater base material 71 is simply referred to as the “thickness direction D”. Further, as viewed in the thickness direction D, a direction intersecting with the longitudinal direction L is referred to as an “intersection direction X”. Herein, in the present embodiment, the sheet P is conveyed from a lower side 71b to an upper side 71a of the heater base material 71. Therefore, in the intersection direction X, a direction from the lower side 71b to the upper side 71a matches the conveyance direction X1.

Further, a direction from the upper side 71a to the lower side 71b of the heater base material 71 can be understood as a reverse conveyance direction X2 opposite to the conveyance direction X1. Note that the intersection direction X can be understood as a direction including both the conveyance direction X1 and the reverse conveyance direction X2.

The heat generation body 72 generates heat by energization. More specifically, the heat generation body 72 employs a material that generates heat by electrical resistance when energized. As illustrated in FIG. 3, the heat generation body 72 is formed so as to extend along the longitudinal direction L. Further, as illustrated in FIG. 3, the heat generation body 72 is provided between two electrode portions 73. The heat generation body 72 may employ, for example, palladium, silver, or the like.

The heater 70 is provided with, as the heat generation bodies 72, a first heat generation body 72a provided on the first surface F1 of the heater base material 71 and a second heat generation body 72b provided on the second surface F2 of the heater base material 71.

The electrode portion 73 supplies power to the heat generation body 72. The electrode portions 73 are formed at both end portions of 71c of the heater base material 71 in the longitudinal direction L. The electrode portion 73 may employ materials such as silver and platinum having low electrical resistance. The electrode portion 73 is exposed without being covered with the insulating layer 75. Further, the power supply terminal 76 is connected to the electrode portion 73.

The heater 70 is provided with, as the electrode portions 73, a first electrode portion 73a provided on the first surface F1 of the heater base material 71 and a second electrode portion 73b provided on the second surface F2 of the heater base material 71.

The power supply terminal 76 is a connector that supplies power to the electrode portion 73. The power supply terminal 76 is connected to each of the electrode portions 73. An adhesive means for attaching the power supply terminal 76 to the electrode portion 73 may employ a heat-resistant adhesive means such as a conductive adhesive, solder, or welding.

The heater 70 is provided with, as the power supply terminals 76, a first power supply terminal 76a connected to the first electrode portion 73a and a second power supply terminal 76b connected to the second electrode portion 73b. Note that, in this specification, the lead wire 77 extending from the first power supply terminal 76a is referred to as a “first lead wire 77a”, and the lead wire 77 extending from the second power supply terminal 76b is referred to as a “second lead wire 77b”.

The insulating layer 75 covers the heat generation body 72, and is provided on each of the first surface F1 of the heater base material 71 and the second surface F2 within a range from which the electrode portion 73 is exposed.

As illustrated in the lower part of FIG. 3, on the first surface F1 of the heater 70, the first electrode portions 73a are formed on both the end portions 71c, and the first heat generation body 72a is provided at the center portion between the two first electrode portions 73a. Further, on the first surface F1 of the heater 70, the conductive portion 74 is provided between the first electrode portion 73a and the first heat generation body 72a, the first heat generation body 72a and the conductive portion 74 are arranged linearly along the longitudinal direction L between the two first electrode portions 73a.

As illustrated in the upper part of FIG. 3, on the second surface F2 of the heater 70, the second electrode portions 73b are formed at both the end portions 71c, and the second heat generation bodies 72b are provided at two locations between the second electrode portions 73b on both ends. Further, on the second surface F2 of the heater 70, the conductive portion 74 is provided between the second electrode portion 73b and the second heat generation body 72b, and the conductive portion 74 is provided between the second heat generation bodies 72b provided at two locations. The second heat generation bodies 72b and the conductive portions 74 are arranged linearly along the longitudinal direction L between the two second electrode portions 73b.

### First Embodiment

The fixing device 60 of the present embodiment fixes an image on the sheet P conveyed in the conveyance direction X1, and includes the pressure roller 62, the fixing belt 61 that has an endless shape and rotates in conjunction with rotation of the pressure roller 62, the fixing pad 63 that slides with respect to the inner circumferential surface of the fixing belt 61, and forms the fixing nip portion FN while nipping the fixing belt 61 between the fixing pad 63 and the pressure roller 62, and the heater 70 that is provided to the fixing pad 63. Further, in the fixing device 60 of the present embodiment, the heater 70 includes the heater base material 71 that has a plate-like shape, the first electrode portions 73a that are respectively provided at both the end portions 71c of the heater base material 71 in the longitudinal direction L on the first surface F1 being one of the front and back surfaces of the heater base material 71, the second electrode portions 73b that are respectively provided at both the end portions 71c on the second surface F2 of the front and back surfaces of the heater base material 71, which is different from the first surface F1, the first heat generation body 72a that is formed to extend along the longitudinal direction L between the two first electrode portions 73a on the first surface F1, and generates heat by energization, and the second heat generation body 72b that is formed to extend along the longitudinal direction L between the two second electrode portions 73b on the second surface F2, and generates heat by energization. The first electrode portion 73a and the second electrode portion 73b are provided at positions that at least partially overlap with each other in the longitudinal direction L as viewed in the thickness direction D of the heater base material 71.

In this manner, in the fixing device 60 of the present embodiment, on each of the front and back surfaces of the heater base material 71, the heat generation body 72 is formed to extend in the longitudinal direction L. Further, in the fixing device 60 of the present embodiment, the heater 70 includes the electrode portion 73 respectively at both the end portions 71c of the heater base material 71, and the electrode portion 73 (the first electrode portion 73a) on the front surface (the first surface F1) and the electrode portion 73 (the second electrode portion 73b) on the back surface (the second surface F2) are provided at the positions overlapping with each other as viewed in the thickness direction D. More specifically, as illustrated in FIG. 3 and FIG. 4, in the heater 70, the first electrode portion 73a and the second electrode portion 73b are arranged at positions facing each other with the heater base material 71 therebetween. Further, the first electrode portion 73a and the second electrode portion 73b are provided at positions at which larger parts thereof overlap with each other as viewed in the thickness direction D. In other words, in the fixing device 60 of the present embodiment, the two heat generation bodies 72 (heat generation patterns) are formed on both the surfaces of the heater base material 71, and the electrode portions 73 corresponding to those heat generation bodies 72 are provided at positions of facing each other with the heater base material 71 therebetween.

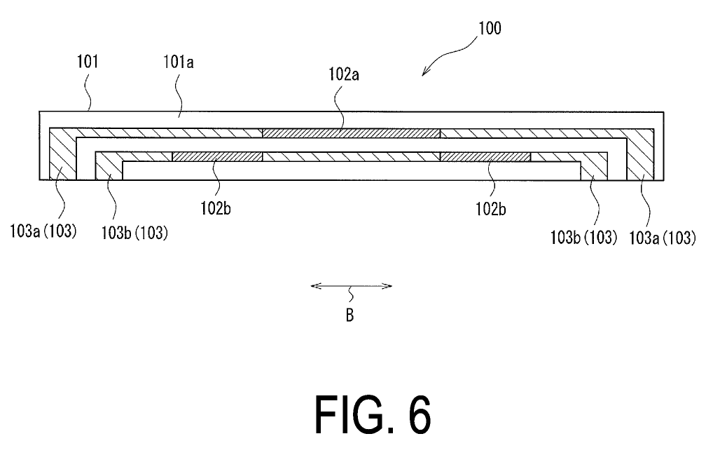

Therefore, in the fixing device 60 of the present embodiment, there is no need to array and arrange four electrode portions in the longitudinal direction L. More specifically, for example, two heat generation patterns (heat generation bodies) are provided on one surface of a heater base material, and electrode portions are provided on both sides of those heat generation bodies. In such a case, when the four electrode portions are arrayed in the longitudinal direction, a space in which the four electrode portions are arrayed and arranged is required (see FIG. 6). In contrast, in the fixing device 60 of the present embodiment, the electrode portions 73 on the front and back surfaces are arranged so as to overlap with each other as viewed in the thickness direction D. Thus, a space for arranging the electrode portions 73 can be reduced. With this, in the fixing device 60 of the present embodiment, the size of the heater 70 in the longitudinal direction L can be reduced. In other words, in the fixing device 60 of the present embodiment, the size of the heater 70 in the longitudinal direction L can be reduced while providing the plurality of heat generation patterns, and the space can be utilized as an arrangement space for other members.

### Second Embodiment

The fixing device 60 of the present embodiment includes the first power supply terminal 76a connected to the first electrode portion 73a and the second power supply terminal 76b connected to the second electrode portion 73b. Further, in the fixing device 60 of the present embodiment, the first power supply terminal 76a and the second power supply terminal 76b are arranged at positions that at least partially overlap with each other in the longitudinal direction L as viewed in the thickness direction D.

With the configuration described above, in the fixing device 60 of the present embodiment, there is no need to array and arrange the four power supply terminals 76 in the longitudinal direction L. More specifically, for example, two heat generation patterns (heat generation bodies) are provided on one surface of a heater base material, and power supply terminals are provided on both sides of those heat generation bodies. In such a case, when the four power supply terminals are arrayed in the longitudinal direction, a space in which the four power supply terminals are arrayed and arranged is required. In contrast, in the fixing device 60 of the present embodiment, the power supply terminals 76 on the front and back surfaces are arranged so as to overlap with each other as viewed in the thickness direction D. Thus, a space for arranging the power supply terminals 76 can be reduced.

With this, in the fixing device 60 of the present embodiment, the size of the heater 70 in the longitudinal direction L can be reduced.

### Third Embodiment

In the fixing device 60 of the present embodiment, the first lead wire 77a extending from the first power supply terminal 76a and the second lead wire 77b extending from the second power supply terminal 76b extend in the intersection direction X intersecting with the longitudinal direction L as viewed in the thickness direction D.

In the fixing device 60 of the present embodiment, the lead wire 77 has a configuration extending to form an L-like shape with respect to a linear line formed by the heat generation body 72 and the conductive portion 74. In other words, in the fixing device 60 of the present embodiment, the lead wire 77 extends to intersect with the longitudinal direction L of the heater 70 so as to be contained within the region of the heater 70 in the longitudinal direction L.

In the fixing device 60 of the present embodiment, the lead wire 77 is attached so that the orientation of the lead wire 77 extending from the power supply terminal 76 corresponds to the orientation forming an L-like shape with respect to the longitudinal direction L of the heater 70 (the conveyance direction X1 or the reverse conveyance direction X2). With this, the space in the axis direction of the fixing device 60 can be minimized. With this, in the fixing device 60 of the present embodiment, the space in the axis direction of the fixing device 60 (the longitudinal direction L) can be minimized, and power can be supplied to the heater 70 with a minimum space even when there is only a limited space for providing the power supply terminal 76. Further, for example, in the image forming apparatus, a gear or a frame may be provided on both sides of the fixing device along the axis. However, according to the fixing device 60 of the present embodiment, the power supply terminal 76 and the lead wire 77 can be prevented from interfering with a gear and a frame.

### Fourth Embodiment

In the fixing device 60 of the present embodiment, the first lead wire 77a and the second lead wire 77b extend in one of the conveyance direction X1 and the reverse conveyance direction X2 opposite to the conveyance direction X1 (in the present embodiment, the reverse conveyance direction X2) in the intersection direction X as viewed in the thickness direction D.

In the fixing device 60 of the present embodiment, the first lead wire 77a and the second lead wire 77b extend in the same direction (in the present embodiment, the reverse conveyance direction X2), and hence appropriate wiring can be achieved even in a small wiring space.

### Fifth Embodiment

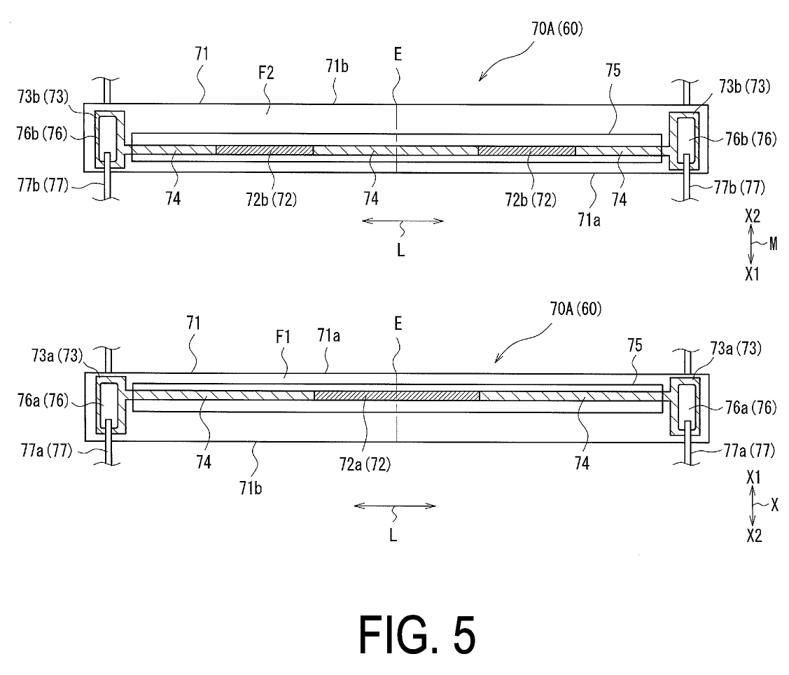

Next, another example of the heater 70 is described. FIG. 5 is a diagram illustrating a state in which a heater 70A according to another example of the heater 70 is viewed in the thickness direction D. The upper part of FIG. 5 illustrates a back surface (second surface F2), and the lower part of FIG. 5 illustrates a front surface (first surface F1).

In the fixing device 60 of the present embodiment, the first lead wire 77a extends in one of the conveyance direction X1 and the reverse conveyance direction X2 opposite to the conveyance direction X1 (in the present embodiment, the reverse conveyance direction X2) in the intersection direction X as viewed in the thickness direction D, and the second lead wire 77b extends in a direction opposite to a direction in which the first lead wire 77a extends, which is one of the conveyance direction X1 and the reverse conveyance direction X2 opposite to the conveyance direction X1, (in the present embodiment, the conveyance direction X1) in the intersection direction X as viewed the thickness direction D.

In this manner, in the fixing device 60 of the present embodiment, the first lead wire 77a and the second lead wire 77b extend in the directions away from each other (opposite directions). With this, in the fixing device 60 of the present embodiment, the insulation distance between the first lead wire 77a and the second lead wire 77b can be secured largely.

### Sixth Embodiment

In the fixing device 60 of the present embodiment, the first heat generation body 72a is formed within a range including an center position E of the heater base material 71 in the longitudinal direction L as viewed in the thickness direction D, and the second heat generation body 72b is formed outward in the longitudinal direction L with respect to the center position E of the heater base material 71 as viewed in the thickness direction D.

In the fixing device 60 of the present embodiment, in the heater 70, the first heat generation body 72a that heats the center of the sheet passing region is formed on one surface of the heater base material 71, the insulating layer 75 covers the front surface of the first heat generation body 72a, and the first electrode portions 73a are provided at both the end portions of the first heat generation body 72a. Meanwhile, the second heat generation body 72b that heats both the ends of the sheet passing region is formed on the other surface of the heater base material 71, the insulating layer 75 covers the front surface of the second heat generation body 72b, and the second electrode portions 73b are provided at both the end portions of the second heat generation body 72b.

According to the fixing device 60 of the present embodiment, the first heat generation body 72a can heat the center portion of the sheet passing region, and the second heat generation body 72b can heat both the end portions of the sheet passing region. Therefore, according to the fixing device 60 of the present embodiment, the sheet P can be heated as appropriate in accordance with the width of the sheet P passing through the fixing nip portion FN.

### Seventh Embodiment

In the fixing device 60 of the present embodiment, the first heat generation body 72a is provided on the surface (the first surface F1) facing the fixing belt 61 of the front and back surfaces of the heater base material 71.

According to the fixing device 60 of the present embodiment, as compared to a case where the heat generation body 72 is provided at the center of the second surface F2, the range including the center portion can be heated quickly.

### Eighth Embodiment

The image forming apparatus 1 of the present embodiment includes the fixing device 60. According to the image forming apparatus 1 of the present embodiment, the size of the heater 70 in the longitudinal direction L can be reduced. Thus, the spaces at both the ends of the fixing device 60 in the axis direction can be utilized.

While the embodiments of the fixing device and the image forming apparatus of the present disclosure are described above, the fixing device and the image forming apparatus of the present disclosure are not limited to the above-described embodiments.

For example, in the embodiments described above, there is given an example in which the first heat generation body 72a that heats the center portion of the sheet passing region is provided on the front surface (the first surface F1) of the heater base material 71, and the second heat generation body 72b that heats both the end portions of the sheet passing region is provided on the back surface (the second surface F2) of the heater base material 71. However, the fixing device and the image forming apparatus of the present disclosure are not limited to the present embodiments. For example, in the fixing device and the image forming apparatus of the present disclosure, the first heat generation body that heats the center portion of the sheet passing region may be provided on the back surface (the second surface) of the heater base material, and the second heat generation body that heats both the end portions of the sheet passing region may be provided on the front surface (the first surface) of the heater base material.

The present disclosure is not limited to the embodiments described above, and can be implemented in various other forms. Therefore, the embodiments are merely illustrative in all respects, and should not be construed in a limiting sense. The scope of the present disclosure is indicated by the claims, and is not restricted by the description in the specification. Furthermore, all modifications and alterations falling within the equivalent scope of the claims are included within the scope of the present disclosure.

1. A fixing device that fixes an image on a sheet conveyed along a conveyance path, the fixing device comprising:
a pressure roller;
a fixing belt that has an endless shape and rotates in conjunction with rotation of the pressure roller;
a fixing pad that slides with respect to an inner circumferential surface of the fixing belt, and forms a fixing nip portion while nipping the fixing belt between the fixing pad and the pressure roller; and
a heater that is provided to the fixing pad, wherein
the heater includes:
a heater base material that has a plate-like shape;
first electrode portions that are respectively provided at both end portions of the heater base material in a longitudinal direction on a first surface being one of front and back surfaces of the heater base material;
second electrode portions that are respectively provided at both the end portions on a second surface of the front and back surfaces of the heater base material, the second surface being different from the first surface;
a first heat generation body that is formed to extend along the longitudinal direction between the two first electrode portions on the first surface, and generates heat by energization; and
a second heat generation body that is formed to extend along the longitudinal direction between the two second electrode portions on the second surface, and generates heat by energization, and
the first electrode portion and the second electrode portion are provided at positions that at least partially overlap with each other in the longitudinal direction as viewed in a thickness direction of the heater base material.

2. The fixing device according to claim 1, further comprising:
a first power supply terminal that is connected to the first electrode portion; and
a second power supply terminal that is connected to the second electrode portion, wherein
the first power supply terminal and the second power supply terminal are arranged at positions that at least partially overlap with each other in the longitudinal direction as viewed in the thickness direction.

3. The fixing device according to claim 2, wherein
a first lead wire extending from the first power supply terminal and a second lead wire extending from the second power supply terminal extend in an intersection direction intersecting with the longitudinal direction as viewed in the thickness direction.

4. The fixing device according to claim 3, wherein
the first lead wire and the second lead wire extend in one of the conveyance direction and a reverse conveyance direction in the intersection direction as viewed in the thickness direction, the reverse conveyance direction being opposite to the conveyance direction.

5. The fixing device according to claim 3, wherein
the first lead wire extends in one of the conveyance directions and a reverse conveyance direction in the intersection direction as viewed in the thickness direction,
the reverse conveyance direction being opposite to the conveyance direction, and
the second lead wire extends in a direction opposite to the direction in which the first lead wire extends, the direction being one of the conveyance direction and a reverse conveyance direction in the intersection direction as viewed in the thickness direction, the reverse conveyance direction being opposite to the conveyance direction.

6. The fixing device according to claim 1, wherein
the first heat generation body is formed within a range including a center position of the heater base material in the longitudinal direction as viewed in the thickness direction, and
the second heat generation body is formed outward in the longitudinal direction with respect to the center position of the heater base material as viewed in the thickness direction.

7. The fixing device according to claim 6, wherein
the first heat generation body is provided on a surface of the front and back surfaces of the heater base material, the surface facing the fixing belt.

8. An image forming apparatus comprising:
the fixing device according to claim 1.
